(19) United States
(12) Patent Application Publication
(10) Pub. No.: US 2007/0006965 A1
(43) Pub. Date: Jan. 11, 2007

(54) Production of gas diffusion electrodes

(76) Inventor: Trygve Burchardt, Trondheim (NO)

Correspondence Address: PATTERSON & SHERIDAN, L.L.P., 3040 POST OAK BOULEVARD, SUITE 1500, HOUSTON, TX, 77056, US

(21) Appl. No.: 10/563,290

(22) PCT Filed: Jul. 2, 2004
(86) PCT No.: PCT/NO04/00205

§ 371 Date: May 9, 2006

(30) Foreign Application Priority Data
Jul. 7, 2003 (NO) 20033110

(51) Int. Cl. B05D 5/12

(52) U.S. Cl. 156/244.24; 427/115

(57) ABSTRACT

A method for the production of a gas diffusion electrode is described, and especially a method for producing a plastic bounded thin gas diffusion electrode with high catalytic activity for the oxygen or the hydrogen reaction. The method comprising the following steps: agglomerating a powder mixture with PTFE particles in a dry form to produce a dry agglomerate; adding an organic solvent to the dry agglomerate to produce a paste; calendering the paste into a thin sheet with a thickness less than 1 mm, to form an active layer or gas diffusion layer, in which one or both contain a current collector; and combining said active layer and said gas diffusion layer to form the gas diffusion electrode. The gas diffusion electrode thus produced may be used for example in fuel cells, metal-air batteries or membranes.

### INTRODUCTION

The invention relates to a method and an apparatus for manufacturing a gas diffusion electrode. Uses of the electrode are also described. In a special embodiment, the electrode is a plastic bonded thin gas diffusion electrode with high catalytic activity for the oxygen or the hydrogen reaction.

### BACKGROUND

Gas diffusion electrodes have been developed for a large number of fuel cell applications and for metal-air battery systems. The most common electrodes are based on polytetrafluoroethylene (PTFE) and activated carbon. The high surface area carbon is used as support for a noble or non-noble metal catalyst. Alternatively, unsupported catalyst can be distributed inside the electrode. The PTFE binds the electrode together and increases the hydrophobicity of the electrode to prevent liquid flooding of the channels for gas transport. Often a metal mesh is present in the electrode as a current collector and/or for mechanical strength.

Two methods have been developed to form mechanically stable electrodes from powders, the wet method and the dry method.

The preparation of the active material and the binder mixture can take place by a ‘wet’ process. This involves introducing the active material and the binder in an organic solvent or water. The slurry is then stirred to obtain a homogeneous mass. Some solvent can also be evaporated by heat treatment. After the electrodes have been calendered and/or pressed into a thin sheet the electrode has to be dried for removal of the last remains of the solvent.

In U.S. Pat. No. 3,457,113 and U.S. Pat. No. 3,706,601 it is known that the binder can be introduced from an aqueous or organic suspension. In this case further heat treatment is required to remove surfactants (wetting agents) used in the PTFE suspension. To remove the wetting agents from the electrode a temperature of over 200° C. is used. At temperatures of more that 300° C. a nitrogen atmosphere is required to prevent oxidation. These temperature steps severely hamper a continuous production line of electrode manufacturing. The electrodes must be heated at a rate <6⁰ /min to prevent cracking of the electrode structure. In addition, the required temperature must be maintained for at least 1 hour to be certain that all the surfactants have evaporated. Therefore, the best method for heat treatment is by inserting a batch in a closed furnace. A furnace connected to a continuous production line will be very expensive and a rate determining step for the total production capacity of the line.

In the German patent publication (Offenlegungsschrift) 2,161,373 the carbon powder and PTFE powder are mixed in a dry state to form an agglomerate. The dry mixture is immediately thereafter pressed onto a metallic-supporting member. In so doing any heat treatment is avoided, and the objective is to plastify the plastic in order to strengthen the electrode. Accordingly, the procedure described in German patent publication (Offenlegungsschrift) No. 2,161,373 has the advantage of requiring little technological effort. In addition, electrodes of good electrochemical activity are obtained because of the absence of elevated temperatures and because there is no coverage of any unnecessary large surface of the mass particles by plastified binders. U.S. Pat. No. 4,336,217 describes a method for preparing the agglomerate from the powder. By using a specially designed paddle mixer with an incorporated cutting head with sharp knifes, the PTFE and carbon powders are mixed homogeneously preventing the dry mixture from adhering and clumping together.

In German patent publication (Offenlegungsschrift) No. 2,161,373 and U.S. Pat. No. 4,336,217 above the agglomerate formed is treated in the dry form. This causes the thin sheet to break easily and handling of the electrode is difficult. Only a limited number of active carbon powders give the agglomerate sufficient mechanical strength to produce the electrodes.

The dry and the wet preparation methods have advantages and disadvantages. With the wet method the plastifying qualities of the agglomerate simplify the calendering step in the electrode production. However, the surfactants acting as wetting agents can only be removed by additional heat treatment. This is problematic for a continuous production line as described above. In the dry method heating is not necessary in the electrode production. However, for the dry method the calendering of the agglomerate to form a thin sheet is problematic. Several calendering steps are required with careful control of the product in order to prevent the thin sheet from cracking and breaking apart. The method is therefore best suited for a batch production line and not continuous production.

In U.S. Pat. No. 5,312,701 an alternative production method is shown. The active layer, where the reaction takes place, and the gas diffusion layer of the electrode are prepared by a filtration method in a single pass [PATH??] process. It is claimed that this is a quicker and more cost-effective method. However, the electrodes have to be heated to 270° C. under pressure in a sintering procedure after the electrodes have been produced. This is a time consuming and slow step that is not well suited for continuous production.

### SUMMARY OF THE INVENTION

It is an objective of the invention to provide a process for the production of thin hydrophobic gas diffusion electrodes which is suitable for continuous production lines and which significantly alleviates the above-mentioned problems.

In a first aspect, the invention provides a method of manufacturing a gas diffusion electrode, the method comprising: agglomerating a powder mixture with PTFE particles in a dry form to produce an agglomerate in dry form; adding an organic solvent to the dry agglomerate to produce a paste; calendering the paste into a thin sheet with a thickness less than 1 mm, to form an active layer or gas diffusion layer, one or both layers containing a current collector; and combining said active layer and said gas diffusion layer to form the gas diffusion electrode.

In one embodiment the method includes using a ball mill for mixing in the agglomeration step. The powders are then mixed for more than 30 minutes. In a further embodiment mixing in the agglomeration step may be performed using a blender with rotating blades, which rotate at a speed at 1000-3000 rpm. The powders are heated prior to agglomeration to a temperature in the range of 50-200° C. The agglomeration time in this embodiment is at least 1 minute. It is also possible to per-form agglomeration using a high-speed mill with blades that rotate at more than 10000 rpm. The agglomeration time in this embodiment is from 10 seconds to 5 minutes.

The solvent may be slowly added to the agglomerate with stirring. The agglomerate may be heated during stirring. The method may in another embodiment comprise extruding the paste into a thin film prior to calendering. A current collector or mechanical support may be calendered into the film.

The powder mixture forming the active layer may comprise 100 wt % graphite. Alternatively, the powder mixture forming the active layer may comprise 25-75 wt % graphite with platinum, and 25-75 wt % graphite. In an even further embodiment the powder mixture forming the active layer comprises 25-75 wt % graphite with Ag, Co, Fe, various perovskites or spinells as a catalyst, and 25-75 wt % graphite. PTFE with a particle size less than 1 mm may be added to the mixture before agglomerating. The powder mixture providing the gas diffusion layer may comprise 55-75 wt % activated carbon or graphite and 25-45 wt % PTFE.

In a further calendering step said electrode may be calendered with a further gas diffusion layer. The layers in the electrode may be combined by calendering or pressing. The electrode may be further dried at a temperature less than 40° C.

The above method is performed in a continuous production line, and the gas diffusion layer and the active layer may be produced in parallel continuous production lines, said production lines being combined in the combining step.

In a further aspect the invention provides an electrode manufactured by the met-hod described above.

In an even further aspect the invention provides a gas diffusion electrode comprising a gas diffusion layer and an active layer, the gas diffusion layer comprising 55-75 wt % activated carbon or graphite and 25-45 wt % PTFE and the active layer comprising 25-75 wt % activated carbon or graphite with noble or non-noble metal catalyst and 25-75 wt % activated carbon or graphite with high surface area (>100 m²/g) and 5-20 wt % PTFE, the gas diffusion layer and the active layer being manufactured according to the method described above.

The gas diffusion electrode produced by the method above, may be used in fuel cells, metal-air batteries or membranes.

In the production method described above the advantage of the dry method and the wet methods are combined, to give gas diffusion electrodes with high activity and good stability, in a continuous production line without the need for heat treatment. Oxygen electrodes and hydrogen electrodes with high reaction rates and long lifetime stability have been developed by the described method. The production method is simple and does not include any high temperature steps or hazardous chemicals. As shown in FIG. 1 the method can be used in a continuous production line.

By using porous electrodes the oxygen reaction and the hydrogen reaction can be performed with high efficiency. Porous electrodes are often made with two layers. One layer is a gas diffusion layer which prevents liquid penetration into the gas chamber, and the other layer is an active layer where the reaction takes place. The two layers are rolled or pressed together to form the electrode. The porous active layer provides a large available surface area and thus high reaction rates.

The active layer is produced with a double pore structure. Hydrophobic pores are used to transport gas into the electrode from the gas chamber. From the electrolyte side hydrophilic pores are filled with the liquid electrolyte. Inside the electrode the reaction takes place on the 3-phase boundary. The main challenge in the production of the electrodes is to make electrodes with both high activity and good stability (>2000 h).

### BRIEF DESCRIPTION OF DRAWINGS

Embodiments of the invention will now be described with reference to the accompanying drawings, in which:

FIG. 1 shows a continuous production line for manufacturing a thin gas diffusion electrode according to an embodiment of the invention;

FIG. 2 shows oxygen reduction from air at 20° C. of electrodes with and without a noble metal catalyst;

FIG. 3 shows a graph of the lifetime of an electrode undergoing oxygen reduction from air at 70° C. at 100 mA/cm² in a galvanostatic experiment at 0.1 A/cm²; and

FIG. 4 shows a gas diffusion electrode manufactured according to an embodiment of the invention, comprising an active layer and a gas diffusion layer with a mesh current collector inside the gas diffusion layer.

### DETAILED DESCRIPTION

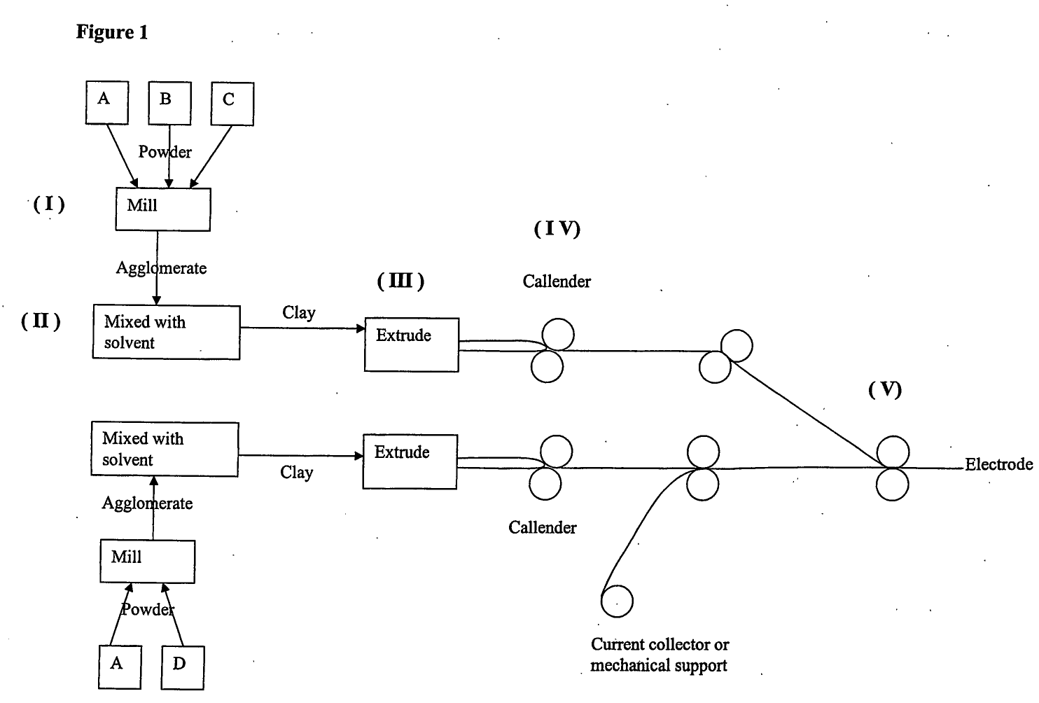

FIG. 1 shows a continuous production line for manufacturing a thin gas diffusion electrode according to an embodiment of the invention. The production line comprises four main steps: (I) a milling and agglomeration step, (II) a mixing step, (III) an extruding step and (IV) a calendering step. However, the extruding step may be omitted and the paste formed in step (II) may be forwarded directly into the calendering step. As shown in FIG. 1 parallel production lines for production of different layers are set up, and the layers can be combined in a step (V) forming an electrode with an active layer and a gas diffusion layer. The different steps will be explained in detail below.

(I) Agglomeration:

As shown in FIG. 1 the first step (I) in the electrode production is the agglomeration of the powder mixture. In FIG. 1 the powder mixture consists of three powders A, B and C. The powders A, B and C are examples only and fewer or more powders may be used. To prevent the removal of surfactants by heat treatment the powder mixture is agglomerated with PTFE particles in the dry form.

Three agglomeration methods are possible:
1. Use of a ball mill. The powders are mixed for at least 30 minutes to obtain a homogeneous agglomerate.
2. Use of a commercially available blender with rotating blades, which rotate at a speed at 1000-3000 rpm. Prior to mixing, the powders are heated to a temperature in the range of 50-200° C. The agglomeration time should be at least 1 minute.
3. Use of a high-speed mill with rotating blades, which rotate at a speed of more than 10000 rpm. The high rotating speed results in rapid agglomeration, and pre-heating of the powders is not necessary to obtain good agglomeration. The agglomeration time is from 10 seconds to 5 minutes.
   (II) Paste Formation:

FIG. 1 part (II) shows the unit for paste formation from the agglomerate. To over-come the severe problems of continuous production from the dry agglomerate, an organic solvent is added after the agglomeration step. The agglomerate is then transformed into a paste, which can easily be made into a thin layer. By adding the solvent after the agglomeration step, wetting agents do not have to be used.

The paste is formed by slowly adding the solvent to the agglomerate with stirring. In this manner the solvent is baked incorporated into the agglomerate and a homogeneous paste is formed. In some cases, especially in the case of a low PTFE content (<10 wt %) or with materials that agglomerate poorly, it is important to plastify the paste further, in such cases the solvent and/or the paste can be heated following the incorporation process.

By this method the problem with the PTFE covering of any unnecessarily large surface of the mass particles by plastified binders as explained earlier, is avoided. This means that high electrocatalytic activity is obtained. In addition no high temperature steps are needed.

By adding the organic solvent after the agglomerate is formed the beneficial properties of a paste in a continuous production line are employed. In this manner the best qualities of the dry and the wet production method are utilised to form a method for cost effective continuous production of gas diffusion electrodes.

(III) Extrusion:

FIG. 1 part (III) shows the extrusion unit. In order to reduce the amount of calendering steps an extrusion unit is used to extrude the paste into a thin film. This step may be omitted, but it is often used to simplify the calendering.

(IV) Calendering:

FIG. 1 part (IV) shows the calendering of the paste. The objective of the calendering is to make a film of uniform thickness. In addition a current collector or mechanical support can be calendered into the film.

The gas diffusion electrode can be made of two layers, an active layer and a gas transport layer. The reaction takes place in the active layer. This layer must have a double pore structure for gas- and liquid transport to the reaction sites. An additional diffusion layer is used to prevent liquid from entering the gas chamber. This layer must have sufficient gas transport properties and high hydrophobicity. Both these layers can be made in the method described above by the agglomeration, paste formation, extrusion and calendering steps. This is shown in FIG. 1 as parallel production lines combining in step (V) forming the electrode. Powders A and D are shown as illustrations only in FIG. 1 for the lower production line, and only one powder or more than two powders may be used.

As shown in FIG. 1 part (V) the two layers are combined in a calendering step. With good extrusion, calendering may be omitted for the individual layers and only one calendering step used to bind the two layers and the current collector together. Pressing can also combine the two layers. The current collector and/or mechanical strength support material can be calendered or pressed into the gas diffusion layer and/or into the active layer and/or between the two layers as illustrated in FIG. 1.

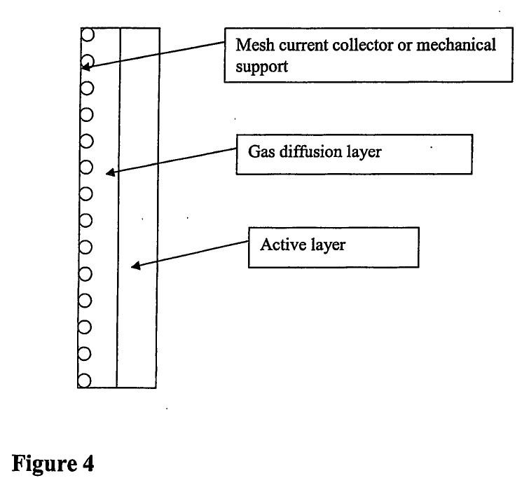

A possible structure of the gas diffusion electrode produced by the method described above is shown in FIG. 4. Reacting gases are transported through the gas diffusion layer and into the active layer. The active layer is partially filled with the electrolyte. Within the active layer the reaction takes place on the three phase boundary between the gas phase, the liquid phase and the catalyst particles.

### EXAMPLES

Gas diffusion electrodes have been made according to the method of the invention, and tested. The gas diffusion electrodes consist of two layers, namely the active layer and the gas diffusion layer. In addition a woven, etched or expanded mesh is pressed or rolled into the gas diffusion electrode.

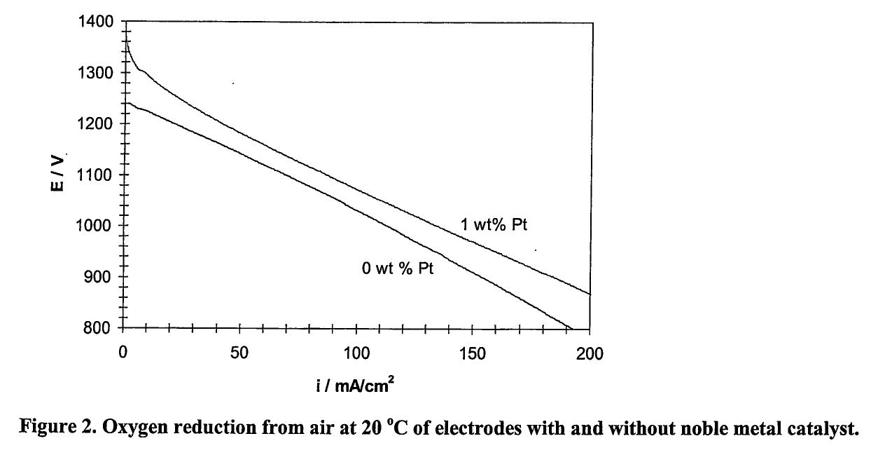

FIG. 2 shows the catalytic activity of two gas diffusion electrodes, one with a noble-metal catalyst and the other without a noble metal catalyst. The electrodes have been prepared by the method according to the invention as described. The electrode without noble metal catalyst was prepared with the use of 15 wt % PTFE and 85 wt % high surface area graphite. The surface area of the graphite must be >100 m²/g. The use of graphite instead of high surface area active carbon is necessary to give long lifetime of the electrodes, however some forms of active carbon may also be used.

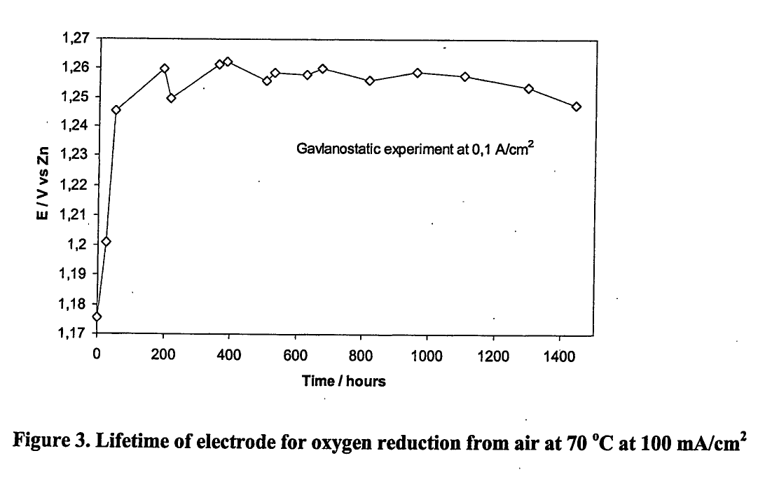

FIG. 3 shows the lifetime study of a gas diffusion electrode with graphite for oxygen reduction. At a current of 100 mA/cm² and a temperature of 70° C. the potential is stable for more than 1400 hours. As shown in the figure, long lifetime is obtained with the use of graphite. This is related to the degradation mechanism of the electrodes. Degradation of gas diffusion electrodes for oxygen reduction is caused by radicals formed in the reaction. These radicals attack the carbon, increasing the hydrophilicity of the electrode and causing flooding of the structure. With graphite, the attacks by radicals are less severe as graphite is more stable than active carbon. High surface area is necessary to create the pore structure for gas and liquid transport. Therefore, the use of high surface area graphite is optimal. The same effect may however also be obtained with some types of active carbon that are especially stable, for instance carbons with a high number of basal planes in the surface structure.

FIGS. 2 and 3 show the high electrocatalytic activity and long lifetime of electrodes produced according to methods of the present invention. Lifetimes for electrodes produced by common electrode production methods should exceed 1000 hours to be of commercial interest. The electrodes produced according to the methods described in this invention are stable for more than 10 000 hours. Also shown in FIG. 2 is an electrode with catalyst. This increases the catalytic activity towards the oxygen reaction. In the figure, graphite with 5 wt % Pt was used for the active layer. To maintain high stability with the high reaction rates on the platinum sites, a graphite support for the catalyst must have a low surface area (<50 m²/g). Other non-noble metal catalysts may also be used on the graphite support for oxygen reduction, for instance Ag, Co, Fe or various perovskites and spinells. In addition a high surface area (>100 m²/g) graphite or activated carbon must be added to give the correct pore structure.

As shown, it is important to use the correct types of carbons and/or graphite in order to obtain high activity and long lifetime. For the active layer, studies have shown that a mix of 25 to 75 wt % graphite with 5 wt % Pt (BET surface area 10 m²/g) and 25 to 75 wt % Timrex HSAG300 graphite from Timcal with BET surface of 280 m²/g gives high activity (>150 mA/cm² at 1 V vs. Zn) and stability (>2000 h). Samples with only Timrex HSAG300 also show high reaction rates (>100 mA/cm² at 1 V vs Zn) and good stability. Before agglomeration PTFE (5-25 wt %) with a particle size of <1 mm was added to the carbon powders.

For the gas diffusion layer our studies have shown that graphite from Timrex (e.g. HSAG300) or activated carbon from Cabot (e.g. Vulcan X72) can be used. Before agglomeration 25-45 wt % of PTFE with a particle size of <1 mm was added to the carbon powder. This gives a gas diffusion layer with high conductivity and hydrophobicity. With 35 wt % PTFE, high hydrophobicity and conductivity in the gas diffusion layer is obtained.

Agglomeration:

Agglomeration is performed in the same manner for the active- and the gas diffusion layer. Adding PTFE to the carbon powder mix produces the agglomerate. The agglomeration was performed in a high-speed mill (20 000 rpm) for 1 min. The ad-vantage of the high-speed mill is the rapid agglomeration from dry powders. With no surfactants (wetting agents) the hydrophobicity of the agglomerate is high.

In order to make a thin sheet electrode from the agglomerate a hydrocarbon solvent is used, for instance Shellsol®. It is added and by slow stirring a paste was formed.

Calendering:

The paste can be extruded and calendered into a thin sheet (<1 mm thick). A Nimesh current collector was calendered into the thin electrode sheet. Also, other materials can be used for the current collector e.g. Ag, silver coated copper, nickel coated copper or carbon composite materials. Alternatively, the current collector can be calendered into the gas diffusion layer. The calendering procedure is performed in the same manner for the gas diffusion layer and the active layer.

Gas Diffusion Electrode Production:

To form the gas diffusion electrode the active- and the gas diffusion layer must be combined. The current collector was calendered into the gas diffusion layer prior to combining it with the active layer. The two layers were combined by calendering them together. After the active layer was rolled together with the gas diffusion layer, the electrode was dried at <40° C. to evaporate the solvent. The total thick-ness of the two-layer electrode should be (400-1000 μm).

The high reaction rates of gas diffusion electrodes are obtained by a large surface area of the 3-phase boundary. However, for use in commercial products, such as fuel cells or metal-air batteries, several other conditions must be met. High stability of the electrodes is essential. The production method must allow rapid production at low costs. In addition the electrodes must be easy to handle and store. The present invention provides a rapid production method for gas diffusion electrodes that enables the use of low cost materials. The electrodes are produced with high electrocatalytic activity and stability. The high mechanical strength enables easy handling and storage of the electrodes.

Having described specific embodiments of the invention it will be apparent to those skilled in the art that other embodiments incorporating the concepts may be used. These and other examples of the invention illustrated above are intended by way of example only and the actual scope of the invention is to be determined from the following claims.

1. A method of manufacturing a gas diffusion electrode, the method comprising:
(a.) agglomerating a powder mixture with PTFE particles in a dry form to produce a dry an agglomerate;
(b.) adding an organic solvent to the dry agglomerate to produce a paste;
(c.) calendering the paste into a thin sheet with a thickness less than 1 mm, to form an active layer or gas diffusion layer, one or both of said layers containing a current collector; and
(d.) combining said active layer and said gas diffusion layer to form a gas diffusion electrode.

2. A method according to claim 1, characterized in that agglomeration is carried out using a ball mill for mixing.

3. A method according to claim 2, characterized in that the powders are mixed for more than 30 minutes.

4. A method according to claim 1, characterized in that agglomeration is carried out using a blender with blades rotating at 1000-3000 rpm.

5. A method according to claim 4, characterized in that the powders are heated to a temperature in the range of 50-200° C. prior to step (a).

6. A method according to claim 4, characterized in that an agglomeration time of at least 1 minute is used.

7. A method according to claim 1, characterized in that agglomeration is carried out using a high-speed mill with rotating blades which rotate at more than 10000 rpm.

8. A method according to claim 7, characterized in that the agglomeration time is from 10 seconds to 5 minutes.

9. A method according to claim 1, characterized in that the solvent is slowly added to the agglomerate with stirring.

10. A method according to claim 9, characterized in that the agglomerate is heated during stirring.

11. A method according to claim 1, characterized in that the paste is extruded into a thin film prior to calendering.

12. A method according to claim 1, characterized in that a current collector or mechanical support is calendered into said film.

13. A method according to claim 1, characterized in that the powder mixture forming the active layer is 100 wt % graphite.

14. A method according to claim 1, characterized in that the powder mixture forming the active layer comprises 25-75 wt % graphite with platinum, and 25-75 wt % graphite.

15. A method according to claim 1, characterized in that the powder mixture forming the active layer comprises 25-75 wt % graphite with Ag, Co, Fe, perovskites or spinells, and 25-75 wt % graphite.

16. A method according to claim 1, characterized in that PTFE with a particle size less than 1 mm is added to the mixture before agglomeration step (a).

17. A method according to claim 1, characterized in that the powder mixture comprises 55-75 wt % activated carbon or graphite and 25-45 wt % PTFE.

18. A method according to claim 1, comprising a further calendering step wherein said electrode is calendered with a further gas diffusion layer made according to the method described in steps (a)-(d).

19. A method according to claim 1, characterized in that said layers are combined in step (d) by calendering or pressing.

20. A method according to claims 1, characterized in that said electrode is dried at a temperature less than 40° C.

21. A method according to claim 1, characterized in that said steps (a)-(d) are performed in a continuous production line.

22. A method according to claim 1, characterized in that said gas diffusion layer and said active layer are produced in parallel continuous production lines and said production lines are combined in the combining step (d).

23. An electrode manufactured by a method according to claim 1.

24. A gas diffusion electrode comprising a gas diffusion layer and an active layer, the gas diffusion layer comprising 55-75 wt % activated carbon or graphite and 25-45 wt % PTFE and the active layer comprising 25-75 wt % activated carbon or graphite with noble or non-noble metal catalyst and 25-75 wt % activated carbon or graphite with high surface area (>1 00 m² μg) and 5-20 wt % PTFE, the gas diffusion layer and the active layer being manufactured according to the method in claim 1.

25. Use of the gas diffusion electrode according to claim 23 in fuel cells, metal-air batteries or membranes.
